(19) United States
(12) Patent Application Publication
(10) Pub. No.: US 2025/0230689 A1
(43) Pub. Date: Jul. 17, 2025

(54) DETACHABLE VEHICLE ROOF PANEL HAVING A LOCKING STRUCTURE

(71) Applicants: HYUNDAI MOTOR COMPANY, Seoul (KR); KIA CORPORATION, Seoul (KR); KWANGJIN CO., LTD., Asan-si (KR)

(72) Inventors: Gook-Hyun Jeon, Hwaseong-si (KR); Hyung-Sik Choi, Hwaseong-si (KR); Jae-Seung Lee, Hwaseong-si (KR); Jun-Hong Jeong, Hwaseong-si (KR); Jae-Hun Cho, Cheonan-si (KR); Won-Don Han, Pyeongtaek-si (KR)

(73) Assignees: HYUNDAI MOTOR COMPANY, Seoul (KR); KIA CORPORATION, Seoul (KR); KWANGJIN CO., LTD., Asan-si (KR)

(21) Appl. No.: 18/952,777

(22) Filed: Nov. 19, 2024

(30) Foreign Application Priority Data
Jan. 16, 2024 (KR) 10-2024-0006708

(51) Int. Cl. E05B 81/08; B60J 7/16; B60J 7/19; E05B 81/18; E05B 81/28; E05B 81/50; E05B 81/56; E05B 81/70; E05C 19/16

(52) U.S. Cl. CPC E05B 81/08; B60J 7/1642; B60J 7/194; E05B 81/18; E05B 81/28; E05B 81/50; E05B 81/56; E05C 19/166; E05B 81/70

(57) ABSTRACT

A detachable roof panel assembly for a vehicle has a locking structure that can be easily locked to secure the roof panel assembly upon mounting the assembly to a roof of the vehicle. The detachable roof panel assembly includes a plurality of roof panels detachably installed on the roof of the vehicle and a locking unit installed on the roof of the vehicle to lock the plurality of roof panels at predetermined positions.

### CROSS-REFERENCE TO RELATED APPLICATION

This application claims priority to Korean Patent Application No. 10-2024-0006708, filed on Jan. 16, 2024, which is incorporated herein by reference in its entirety.

### BACKGROUND

### Field of the Disclosure

The present disclosure relates to a roof panel assembly, which is detachable from a roof of a vehicle, and more specifically, to a detachable roof panel assembly for a vehicle, which has a locking structure that can be easily locked to the roof when installed.

### Description of Related Art

A technology for opening a roof of a vehicle so that passengers can feel a greater sense of openness is currently being applied to vehicles.

For example, in some vehicle models, by allowing an occupant to drive in a state in which a roof is opened by detaching a roof panel of a vehicle, the occupant can feel an expanded sense of openness.

When the roof panel is mounted, the occupant mounts the roof panel by manipulating a locking lever and a locking clamp installed on the roof panel to prevent the roof panel from being separated from the roof. The vehicle is provided with a plurality of roof panels, and each roof panel typically includes a plurality of locking levers and one locking clamp. After the roof panel is temporarily mounted by manipulating the locking lever to rotate in a state in which the roof panel is seated on the roof, the roof panel is locked by manipulating the locking clamp.

When the roof panel is separated from the roof, the roof panel is unlocked by manipulating the locking clamp, and the roof panel is separated by rotating each locking lever.

Since the plurality of roof panels are applied to the roof of the vehicle, there is a problem in that it is not easy to remove or mount the roof panel because many parts need to be manipulated for the removal or installation of the roof panel.

As described above, there is a problem in that since it is inconvenient for an occupant to attach and detach the roof panel, the frequency of removing and obtaining the benefit of the roof panel is reduced.

### SUMMARY

The present disclosure is provided to solve the above mentioned problems and is directed to providing a detachable roof panel assembly for a vehicle. The detachable roof panel assembly has a locking structure in which a roof panel can be locked or unlocked with one-time manipulation when the roof panel is removed from or mounted in a vehicle.

To achieve the objects, a detachable roof panel assembly for a vehicle includes a plurality of roof panels configured to be attached and detached from a roof of the vehicle. The assembly also includes a locking unit coupled to the roof of the vehicle and configured to lock predetermined positions of the plurality of roof panels.

The locking unit may constrain and lock strikers on the roof panels when the plurality of roof panels are mounted on the roof.

The locking unit may include a locking bar configured to constrain the strikers or be moved rearward when pressed by the strikers. The locking unit may also include a solenoid configured to allow the locking bar to move rearward when power is applied to separate the locking bar from the striker.

A front end of the locking bar may be formed to have an inclined surface to slide toward an inside of the solenoid when pressed by the striker.

The solenoid may elastically support the locking bar so that the locking bar moves forward when the power is cut off.

The plurality of roof panels may include a front roof panel and a rear roof panel. The locking unit may be installed on a center roof rail of the vehicle to lock a rear end of the front roof panel and a front end of the rear roof panel.

A magnet unit may be configured to fix at least one side of each of the plurality of roof panels to the roof with a magnetic force.

The magnet unit may include a magnetic iron core in contact with steel plates installed on the plurality of roof panels, a fixed permanent magnet fixedly coupled to the magnetic iron core, a rotary permanent magnet rotatably disposed at a position spaced by a predetermined distance from the fixed permanent magnet of the magnetic iron core, and a coil wound around the magnetic iron core and magnetized when power is applied to rotate the rotary permanent magnet.

When the power is applied to the coil and the rotary permanent magnet is arranged in the same direction as the fixed permanent magnet in a state in which the steel plate is attached to the magnetic iron core, a magnetic path may be formed to pass through the magnetic iron core and the steel plate so that the plurality of roof panels is fixed to the roof.

When the power is applied to the coil and the rotary permanent magnet and the fixed permanent magnet are arranged in opposite directions, the magnetic path passing through the steel plate may be removed so that the plurality of roof panels may be separated from the roof.

The magnet unit may be disposed on a center roof rail of the vehicle at an interval to fix a rear end of a front roof panel and a front end of a rear roof panel and may be disposed on an upper end of a rear pillar of the vehicle to fix the rear end of the rear roof panel.

The detachable roof panel assembly may further include an ajar switch configured to detect whether installation of the plurality of roof panels is finished.

The detachable roof panel assembly may include a control unit configured to receive a signal from the ajar switch whether the installation of the plurality of roof panels is finished, output a locking signal of the locking unit or receive an unlock signal generated by pulling the roof panel by an occupant from the locking unit, and operate a magnet unit configured to fix the roof panel with a magnetic force.

An unlock button may be installed inside the vehicle and configured to be manipulated by the occupant before the occupant operates a micro-switch of the locking unit by pulling the roof panel. Additionally, an output signal of the unlock button may be input to the control unit.

Any one of the plurality of roof panels may include a guide pin protruding toward a roof rail of the vehicle at one side thereof. Additionally, a guide holder may be configured to accommodate the guide pin in the roof rail.

An accommodating groove configured to accommodate the guide pin may be formed inside the guide holder.

The guide pin may be formed to have a smaller cross-sectional area toward an end portion thereof and a spherical head may be formed on the end portion of the guide pin. An inner end portion of the accommodating groove may be formed in a shape corresponding to the head.

The accommodating groove may be formed to be inclined toward the top of the vehicle.

The accommodating groove may be formed to have a larger width toward an inlet thereof.

The guide pins may be formed at intervals on a front end of a front roof panel in a width direction of the vehicle. The guide holders may be formed at intervals on a front roof rail in the width direction of the vehicle.

According to the detachable roof panel assembly, which has the locking structure according to the present disclosure having the above configuration, it is possible to automatically lock the roof panel on the roof of the vehicle with one-time manipulation after the roof panel is mounted. Additionally, it is possible to lift and remove the roof panel by automatically unlocking the roof panel with one-time pulling manipulation upon removal from the roof.

As described above, since there is no need to perform multiple installation or removal manipulations along the perimeter of the roof panel, the user's convenience is improved.

### BRIEF DESCRIPTION OF THE DRAWINGS

FIG. 1 is a perspective view showing a state in which a roof panel is mounted in a vehicle to which a detachable roof panel assembly for a vehicle according to the present disclosure is applied.

FIG. 2 is a perspective view showing a state in which the roof panel is removed from a vehicle to which a detachable roof panel assembly according to the present disclosure is applied.

FIGS. 3A-3C are a perspective view, a plan view, and a side view showing a state in which a guide pin is fastened to a guide holder in a detachable roof panel assembly according to the present disclosure.

FIG. 4 is a side view showing a process of mounting a detachable roof panel assembly according to the present disclosure on a front roof rail.

FIG. 5 is a side view showing a state in which a detachable roof panel assembly according to the present disclosure is mounted on a front roof rail of a vehicle.

FIG. 6 is a schematic diagram showing an example in which a guide pin, a locking unit, a magnet unit, a micro-switch, and an ajar switch are disposed on a detachable roof panel assembly according to the present disclosure.

FIG. 7 is an exploded perspective view of a locking unit in a detachable roof panel assembly according to the present disclosure.

FIG. 8 is a bottom perspective view of a magnet unit in a detachable roof panel assembly according to the present disclosure.

FIGS. 9A-9E are schematic diagrams showing an operation principle of a magnet unit in a detachable roof panel assembly according to the present disclosure.

FIG. 10 is a schematic diagram showing a state in which a detachable roof panel assembly according to the present disclosure is locked.

FIG. 11 is a schematic diagram showing a state in which a front roof panel is being assembled in a detachable roof panel assembly according to the present disclosure.

FIGS. 12 and 13 are schematic diagrams showing a state in which a front roof panel is being locked in a detachable roof panel assembly according to the present disclosure.

FIGS. 14 and 15 are schematic diagrams showing a state in which a front roof panel has been locked in a detachable roof panel assembly according to the present disclosure.

FIGS. 16 and 17 are schematic diagrams showing a state in which a front roof panel is being unlocked in a detachable roof panel assembly according to the present disclosure.

FIGS. 18 and 19 are schematic diagrams showing a state in which a front roof panel is being further unlocked in a detachable roof panel assembly according to the present disclosure.

FIG. 20 is a schematic diagram showing a state in which a rear roof panel is being mounted in a detachable roof panel assembly according to the present disclosure.

FIG. 21 is a schematic diagram showing a state in which a rear roof panel has been mounted in a detachable roof panel assembly according to the present disclosure.

FIG. 22 is a schematic diagram showing a state in which a rear roof panel starts to be unlocked in a detachable roof panel assembly according to the present disclosure.

FIG. 23 is a schematic diagram showing a state in which a rear roof panel has been separated in a detachable roof panel assembly according to the present disclosure.

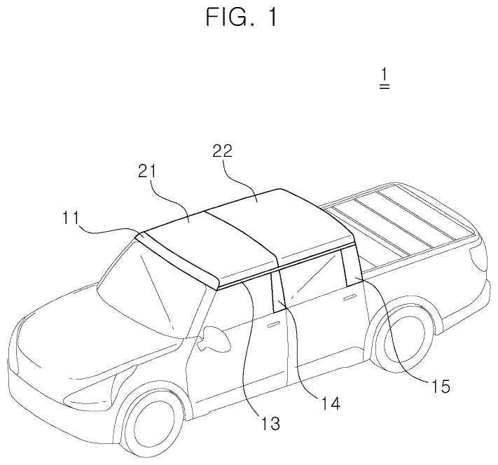

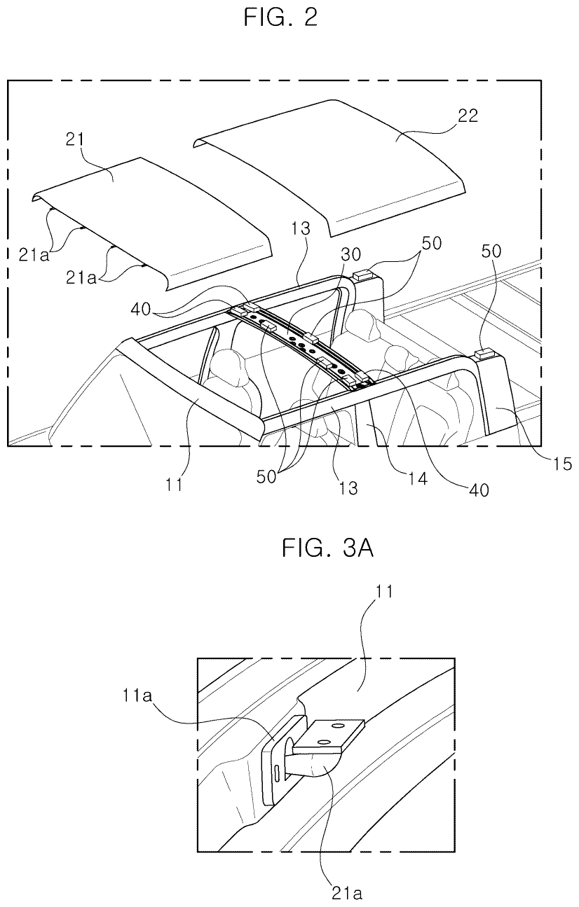

### DETAILED DESCRIPTION

Hereinafter, a detachable roof panel assembly according to the present disclosure is described in detail with reference to the accompanying drawings.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

A detachable roof panel assembly for a vehicle according to the present disclosure includes a plurality of roof panels 21 and 22 detachably installed on a roof of a vehicle 1. The detachable roof panel assembly includes a locking unit 40 installed on the roof of the vehicle to lock each of the plurality of roof panels 21 and 22 at predetermined positions.

The roof of the vehicle forms a structure by a front roof rail 11 and a center roof rail 12 disposed in a width direction of the vehicle 1 and by a roof side rail 13 installed in a longitudinal direction of the vehicle to connect the side ends of the front roof rail 11 to the side ends of the center roof rail 12. A portion in which the front roof rail 11 and the roof side rail 13 are connected is connected to an upper end of a front pillar, a portion in which the center roof rail 12 and the roof side rail 13 are connected is connected to an upper end of a center pillar 14, and a rear end of the roof side rail 13 is connected to an upper end of a rear pillar 15.

A structure is formed by a perimeter of the roof of the vehicle 1 as described above. The roof panels 21 and 22 are mounted on the structure to complete the roof of the vehicle 1.

According to the present disclosure, by installing the roof panels 21 and 22 in a detachable manner rather than permanent installation, the roof panels 21 and 22 may be removed as needed. Normally, the roof panels 21 and 22 are provided to be fixed to the roof of the vehicle 1. Accordingly, the present disclosure is provided to install the roof panels 21 and 22 to the roof of the vehicle 1 in a detachable manner.

The roof panels 21 and 22 may be provided as the front roof panel 21 and the rear roof panel 22, disposed rearward of the front roof panel 21. In another alternative, the front roof panel 21 and the rear roof panel 22 may be provided in a form that is further divided into left and right sides or in a form replacing them with left and right side roof panels that are split longitudinally.

To fix perimeters of the plurality of roof panels 21 and 22, i.e., the front roof panel 21 and the rear roof panel 22, a guide holder 11a is provided to which a guide pin 21a, installed at a front end of the front roof panel 21, is fixed. Additionally, a locking unit 40 and a magnet unit 50 are provided for fixing the perimeters of the front roof panel 21 and the rear roof panel 22 are provided.

The guide holder 11a, the locking unit 40, and the magnet unit 50 are installed on the roof to fix the perimeters of the plurality of roof panels 21 and 22. The guide pin 21a and the magnet unit 50 fix the perimeters of the roof panels 21 and 22 to the roof so that the roof panels 21 and 22 are mounted to the roof. The locking unit 40 mechanically locks the plurality of roof panels 21 and 22 to prevent the plurality of roof panels 21 and 22 from being separated from the roof.

First, a fixed structure using the guide pin 21a is described.

The guide pin 21a is formed to protrude from the roof panel 21 of the plurality of roof panels 21 and 22 toward the front roof rail 11. The guide holder 11a for accommodating the guide pin 21a is formed on the front roof rail 11. Therefore, when the guide pin 21a is fitted into the guide holder 11a, one side of the roof panel 21 is fixed. In other words, a front end of the front roof panel is fixed to the front roof rail 11.

The guide pin 21a is formed to protrude from the front end of the front roof panel 21 toward the front roof rail 11. The guide holder 11a is formed on the front roof rail 11.

A plurality of the guide pins 21a are disposed at intervals at the front end of the front roof panel 21. The guide holders 11a are formed or disposed at intervals at positions of the front roof rail 11 that correspond to the guide pins 21a.

To allow the guide pins 21a to be easily inserted into the guide holders 11a, each guide pin 21a is formed to have a smaller cross-sectional area toward an end portion thereof and to have a spherical head 21b on the end portion of the guide pin 21a.

An accommodating groove 11b for accommodating the guide pin 21a is formed in each guide holder 11a. In particular, an inner end portion of the accommodating groove 11b is formed in a shape corresponding to a shape of the head 21b.

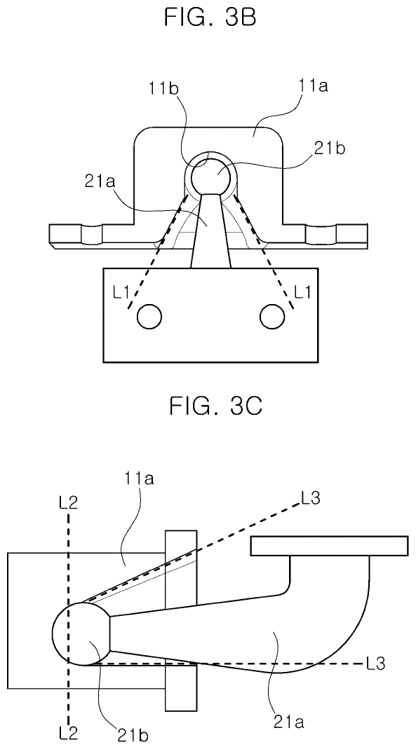

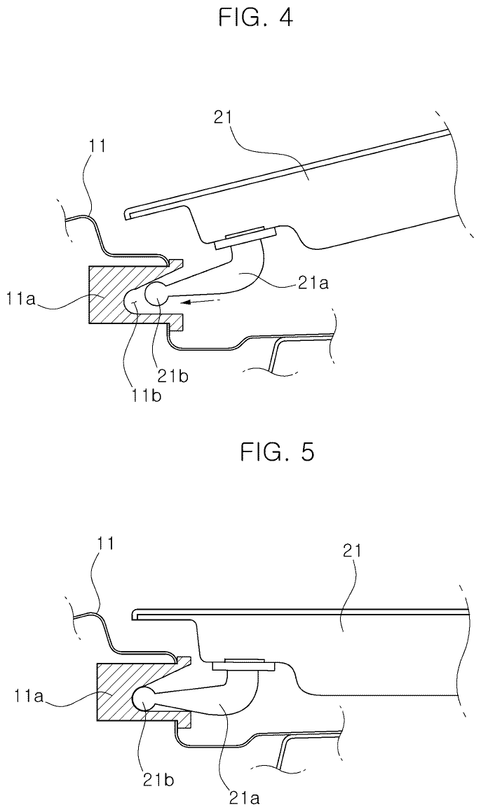

In particular, the accommodating groove 11b is formed to have a larger width toward an inlet of the accommodating groove 11b so that the guide pin 21a may be easily inserted. In other words, as shown in FIG. 3B, an inner surface of the accommodating groove 11b is formed along a line L1 to have a larger width toward the inlet thereof. Therefore, the accommodating groove 11b guides the guide pin 21a to be inserted and released in the width direction of the vehicle 1.

In addition, an upper surface of the accommodating groove 11b is formed to be inclined upward. A lower surface of the accommodating groove 11b is formed substantially flat, but the upper surface of the accommodating groove 11b is formed to be inclined toward the top of the vehicle 1 (see line L3). This guides the guide pin 21a to be inserted and released in a height direction of the vehicle 1.

In addition, the inner end portion of the accommodating groove 11b is formed to correspond to the shape of the head 21b to restrict the movement of the guide pin 21a in the longitudinal direction of the vehicle 1.

With this structure, after the guide pin 21a is inserted into the accommodating groove 11b when the front end of the front roof panel 21 on which the guide pin 21a is formed is tilted to be inclined downward, a rear end of the front roof panel 21 is moved down to allow the front roof panel 21 to be mounted.

The magnet unit 50 fixes at least one side of the roof panels 21 and 22 to the roof with a magnetic force. The magnet unit 50 does not mechanically lock the roof panels 21 and 22 but fixes the roof panels 21 and 22 with a magnetic force to restrict the movement of the plurality of roof panels 21 and 22.

Steel plates 21e and 22c are installed on the front roof panel 21 and the rear roof panel 22, respectively. Thus, the steel plates 21e and 22c are fixed by the magnet unit 50.

The magnet unit 50 includes a magnetic iron core 51 in contact with the steel plates 21e and 22c and includes a fixed permanent magnet 52 fixedly installed on the magnetic iron core 51. The magnet unit 50 also includes a rotary permanent magnet 53 rotatably installed at a position of the magnetic iron core 51 spaced by a predetermined distance from the fixed permanent magnet 52. The magnet unit 50 also includes a coil 54 wound around the magnetic iron core 51 and magnetized when electric power is applied to rotate the rotary permanent magnet 53.

The magnetic iron core 51 forms a magnetic path with the fixed permanent magnet 52. However, when the rotary permanent magnet 53 is rotated by the magnetization of the coil, a magnetic path to the rotary permanent magnet 53, the magnetic iron core 51, and the steel plates 21e and 22c is formed to fix the front roof panel 21 to the rear roof panel 22.

In other words, when electric power is applied to the coil 54 to magnetize the coil 54 so that the rotary permanent magnet 53 is arranged in the same direction as the fixed permanent magnet 52 when the steel plates 21e and 22c are attached to the magnetic iron core 51, the magnetic path is formed to pass through the magnetic iron core 51 and the steel plates 21e and 22c to fix the plurality of roof panels 21 and 22 to the roof.

When the rotary permanent magnet 53 and the fixed permanent magnet 52 are arranged in different directions by magnetizing the coil 54 in an opposite direction when the front roof panel 21 and the rear roof panel 22 are fixed by the magnetic force, the magnetic path passing through the steel plates 21e and 22c is released. Thus, the front roof panel 21 and the rear roof panel 22 may be separated.

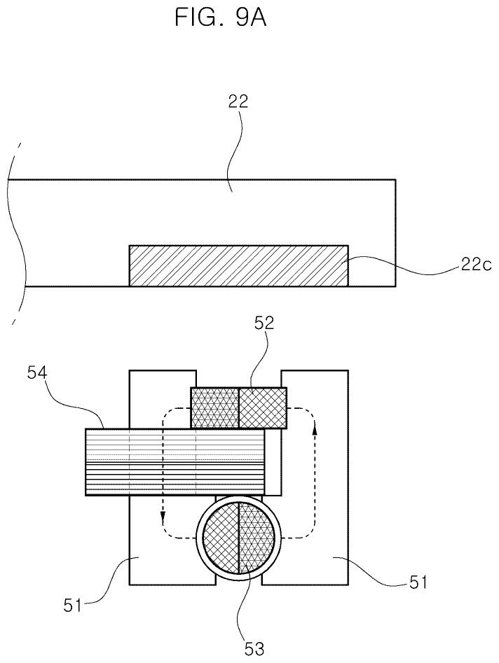

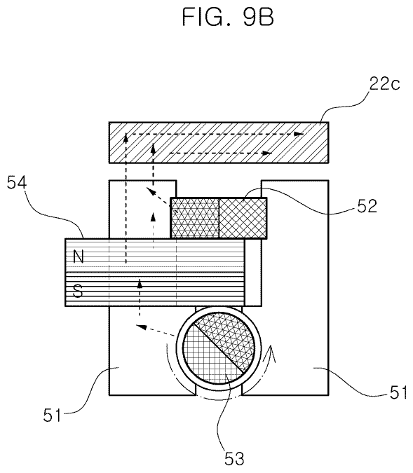

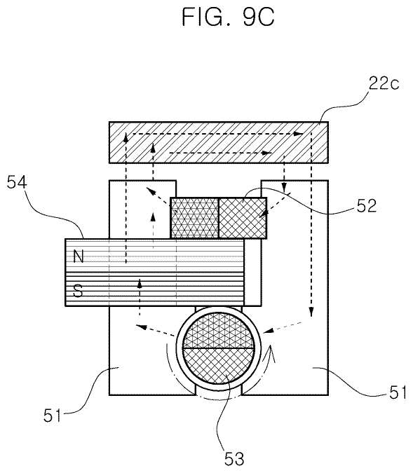

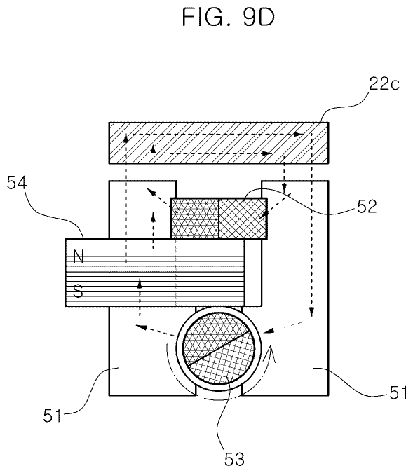

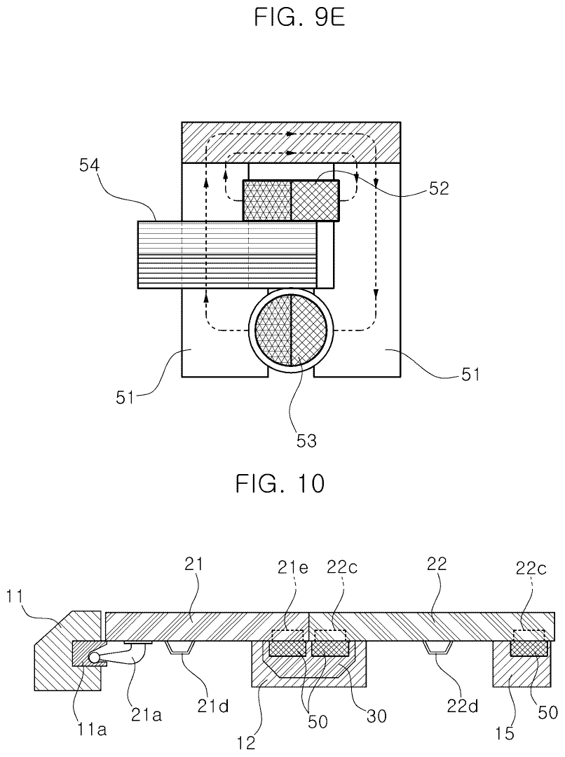

FIGS. 9A-9E show a process in which the rear roof panel 22 is fixed.

FIG. 9A shows a state before the rear roof panel 22 is in contact with the roof.

When the steel plate 22c of the rear roof panel 22 is close to the magnetic iron core 51 (see FIG. 9B), the magnetic path to the fixed permanent magnet 52, the magnetic iron core 51, and the steel plate 22c is formed. Thus, the rear roof panel 22 cannot be firmly fixed. In this state, a current is applied to the coil 54 to rotate the rotary permanent magnet so that the fixed permanent magnet 52 and the rotary permanent magnet 53 are arranged in the same direction (see FIGS. 9C and 9D). Then, when the fixed permanent magnet 52 and the rotary permanent magnet 53 are arranged in the same direction, the magnetic path passing through the rotary permanent magnet 53 and the steel plate 22c is formed. Thus, the rear roof panel 22 is firmly fixed by the magnetic force.

The locking unit 40 mechanically locks at least one side of the plurality of roof panels 21 and 22. Also, the locking unit 40 locks the perimeters of the plurality of roof panels 21 and 22 at a predetermined point. The locking unit 40 locks the plurality of roof panels 21 and 22 fixed by the guide pin 21a and the magnet unit 50 to prevent the roof panels 21 and 22 from being separated from the roof.

The locking unit 40 includes a locking bar 44 for constraining striker 21c provided on the plurality of roof panels 21 and 22 or moving rearward when pressed by the striker 21c. The locking unit 40 also includes a solenoid 42 for moving the locking bar 44 rearward when electric power is applied to separate the locking bar 44 from the striker 21c.

The locking bar 44 is installed to slide on a base 41 of the locking unit 40.

A solenoid fixing unit 41a for accommodating the solenoid 42 is formed in the base 41. In addition, an operation groove 41b is formed in the base 41. The operation groove 41b is a space where the striker 21c enter and exit. Additionally, the operation groove 41b constrains and releases the entry and exit of the striker 21c. The locking bar 44 is slidably installed to constrain the striker 21c or to move rearward when pressed by the striker 21c inside the operation groove 41b.

The locking bar 44 is formed to have an inclined surface 44a to slide inward from the solenoid 42 when a front end of the locking bar 44 is pressed by the striker 21c.

When electric power is applied, the solenoid 42 moves the locking bar 44 rearward to separate the locking bar 44 from the striker 21c.

When the electric power is cut off, the solenoid 42 elastically supports the locking bar 44 so that the locking bar 44 moves forward.

A release bar 45 is installed parallel to the locking bar 44 and a locking bracket 46 for locking the release bar 45 is provided. The release bar 45 locks the striker 21c together with the locking bar 44.

The locking bar 44 and the release bar 45 are disposed between two cover panels 43. A separation panel 47 is disposed between the locking bar 44 and the release bar 45. A fastening bolt is assembled by passing through the cover panel 43, the locking bar 44, the release bar 45, and the cover panel 43. Additionally, a bearing 48 is fitted into an outer side of the fastening bolt to reduce friction at operation.

Only a locking operation between the front roof panel 21 and the locking unit 40 is shown in the drawings. The rear roof panel 21 is also locked in the same manner according to the same operation.

An ajar switch 62 for detecting whether the installation of the plurality of roof panels 21 and 22 is finished is installed on the locking unit 40.

In addition, the locking unit 40 includes a micro-switch 49 operated when the occupant pulls the roof panels 21 and 22 to separate the plurality of roof panels 21 and 22.

A control unit 70 is configured to receive information, such as a signal, from the ajar switch 62 whether the installation of the plurality of roof panels 21 and 22 is finished. The control unit 70 is also configured to output a locking signal to the locking unit 40 or receive an unlock signal generated by pulling the plurality of roof panels 21 and 22 by the occupant from the locking unit 40. Furthermore, the control unit 70 is configured to operate the magnet unit 50 for fixing the roof panels 21 and 22 with the magnetic force.

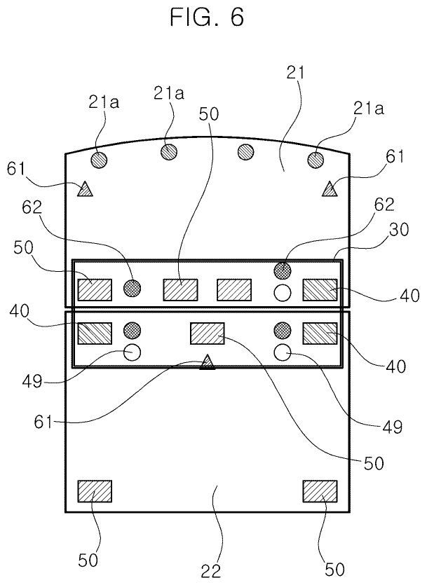

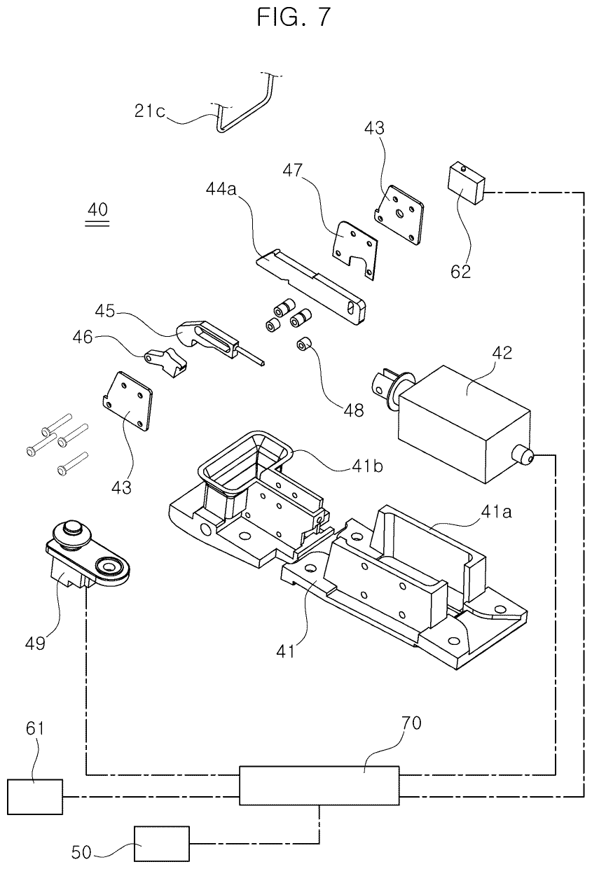

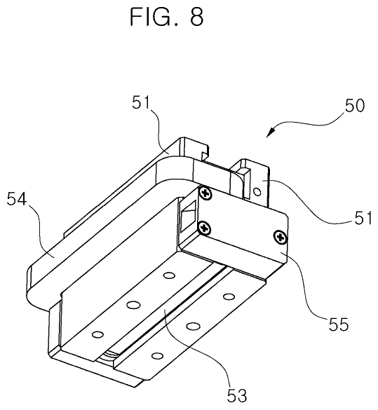

FIG. 6 shows the installation relationship between the guide pins 21a, the locking units 40, the magnet units 50, the ajar switches 62, the micro-switches 49, the front roof panel 21, and the rear roof panel 22. As shown in FIG. 6, it is desirable that the number of locking units 40 used to secure the roof panels 21 and 22 is small. One locking unit 40 is installed to fix the front roof panel 21 and two locking units 40 are installed for fixing the rear roof panel 22. As a result, the configuration reduces mechanical operation and allows the roof panels 21 and 22 to be easily attached and detached.

Each locking unit 40 is installed on the center roof rail 12 of the vehicle 1 to lock the rear end of the front roof panel 21 and a front end of the rear roof panel 22. In other words, a module plate 30 is installed on the center roof rail 12, and some or all of the locking units 40, the magnet units 50, the ajar switches 62, the micro-switches 49, and the like are installed on the module plate 30.

In addition, an unlock button 61 may be manipulated before removing the front roof panel 21 and the rear roof panel 22. In certain examples, a plurality of unlock buttons 61 may be installed. In other words, an unlock button 61 may be installed on at least one interior side of each roof panel 21 and 22 of the vehicle. Each unlock button 61 is connected to the control unit 70 so that a micro-switch 49 is activated after the unlock button 61 is manipulated by the occupant. This is achieved to prevent the locking units 40 and the magnet units 50 from being unlocked when a micro-switch 49 is pressed regardless of the occupant's intention. In other words, only when a signal from a micro-switch 49 is input after a signal is input from an unlock button 61 are the locking units 40 and the magnet units 50 are unlocked.

An operation of the detachable roof panel assembly for a vehicle having the above configuration is described below.

FIG. 10 shows a schematic diagram showing a state in which the roof panel assembly according to the present disclosure is mounted on the roof of the vehicle.

As depicted in FIG. 10, the front end of the front roof panel 21 is fixed to the front roof rail 11 by the guide pin 21a, a portion of the rear end thereof is locked by the locking unit 40, and the remaining portion of the rear end is fixed by the magnet unit 50.

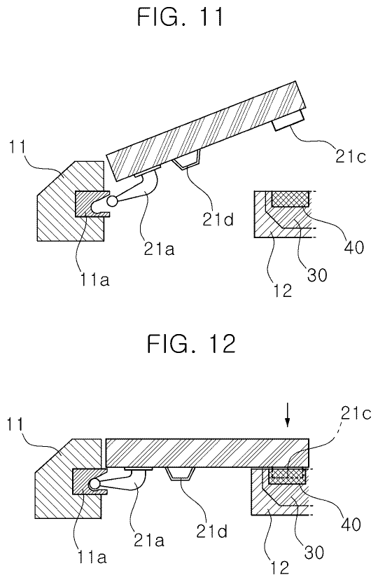

First, the front end of the front roof panel 21 is inclined downward to allow the front roof panel 21 to enter the front roof rail 11 so that the guide pin 21a is inserted into the corresponding guide holder 11a (see FIG. 11).

When the front end of the front roof panel 21 is coupled to the front roof panel 21, the rear end of the front roof panel 21 is pulled downward so that the rear end of the front roof panel 21 is in contact with the module plate 30 (see FIG. 12).

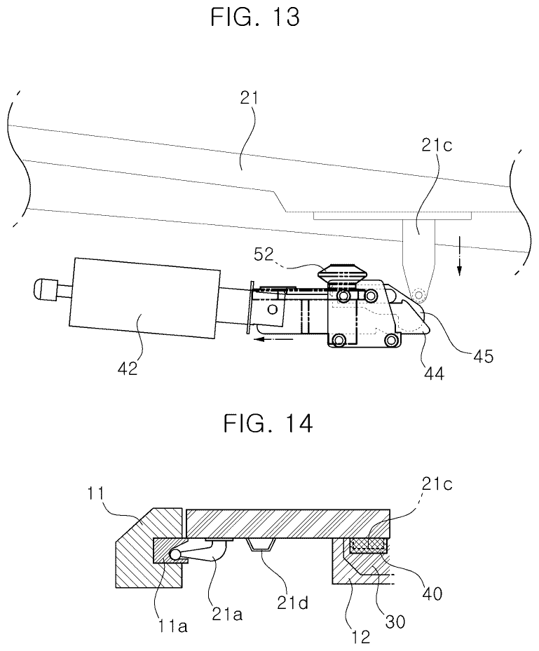

When the rear end of the front roof panel 21 moves down, the striker 21c of the front roof panel 21 passes through the locking bar 44 and the release bar 45 of the locking unit 40 while allowing the locking bar 44 and the release bar 45 to move down (see FIG. 13).

After the striker 21c passes through the locking bar 44 and the release bar 45, the locking bar 44 and the release bar 45 are moved forward by a spring mounted inside the solenoid 42 to lock the striker 21c and thus lock the rear end of the front roof panel 21.

In addition, when the downward movement of the rear end of the front roof panel 21 is finished, a completed or finished installation signal of the front roof panel 21 is output from the ajar switch 62 to the control unit 70.

When receiving the completed installation signal of the front roof panel 21 from the ajar switch 62, the control unit 70 operates the magnet unit 50 to fix the position corresponding to the magnet unit 50 of the rear end of the front roof panel 21 with the magnetic force.

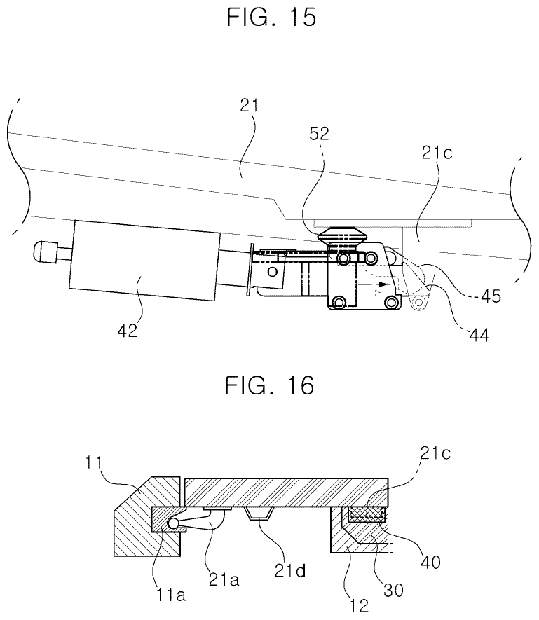

With such a process, the front and rear ends of the front roof panel 21 are fixed to the front roof rail 11 and the center roof rail 12 (see FIGS. 14 and 15).

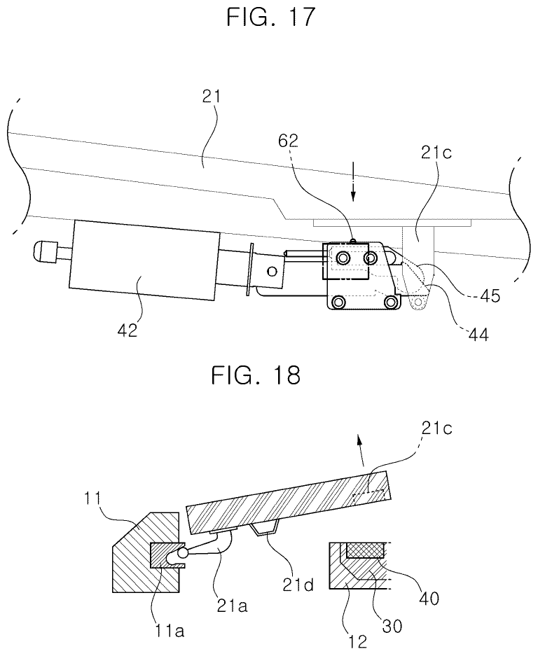

To remove the front roof panel 21, the occupant manipulates the unlock button 61 and then pulls down on a handle 21d formed on a bottom surface of the front roof panel 21 (see FIGS. 16 and 17).

When the front roof panel 21 is pulled down, the front roof panel 21 presses the micro-switch 49 so that the signal is output from the micro-switch 49 to the control unit 70. In particular, since the unlock button 61 is manipulated first, an output signal of the micro-switch 49 becomes a valid signal.

When the signal is input to the control unit 70 from the micro-switch 49 positioned under the front roof panel 21, the control unit 70 operates the locking unit 40 and the magnet unit 50 constraining the rear end of the front roof panel 21 to unlock the rear end of the front roof panel 21.

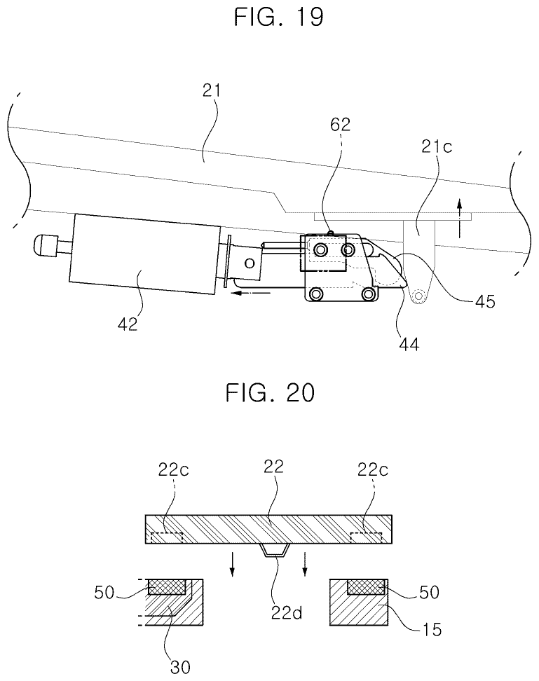

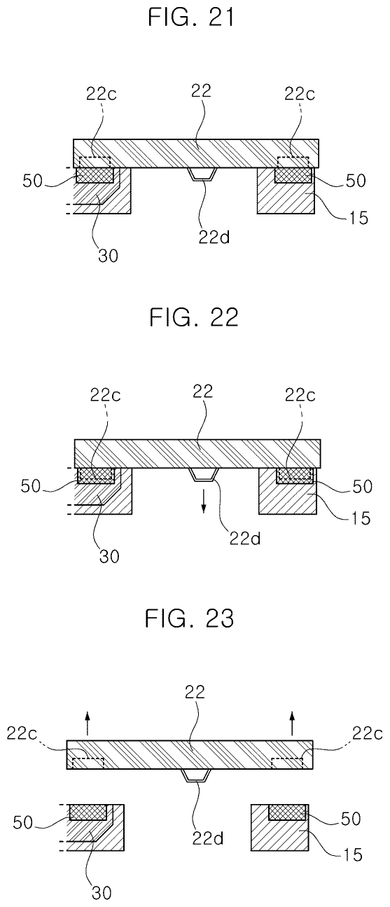

When the control unit 70 operates the locking unit 40 for unlocking, as the locking bar 44 and the release bar 45 are moved rearward by the solenoid 42 (see FIG. 19), the locking unit 40 unlocks the rear end of the front roof panel 21.

When the control unit 70 operates the magnet unit 50 so that the fixed permanent magnet 52 and the rotary permanent magnet 53 are aligned in opposite directions, the steel plate 21e of the front roof panel 21 is not fixed by the magnet unit 50.

As described above, when the rear end of the front roof panel 21 is unlocked, the occupant first lifts the rear end of the front roof panel 21 to be separated from the center roof rail 12 (see FIG. 18). In addition, when the front end of the front roof panel 21 is separated from the front roof rail 11 so that the guide pin 21a is separated from the corresponding guide holder 11a, the front roof panel 21 may be removed.

In a process of mounting the rear roof panel 22, when the rear roof panel 22 is moved down so that the front and rear ends of the rear roof panel 22 are seated on the front end of the center roof rail 12 and the upper end of the rear pillar 15, respectively, the rear roof panel 22 is fixed to the front end of the center roof rail 12 and the upper end of the rear pillar 15.

When the rear roof panel 22 is moved down (see FIG. 20) so that each of the front and rear ends of the rear roof panel 22 pass through the locking unit 40, the striker 22a of the rear roof panel 22 passes through the locking bar 44 and the release bar 45 of the locking unit 40, which lock the rear roof panel 22. As a result, the rear roof panel 22 is locked to the locking unit 40. When the rear roof panel 22 is moved down and locked to the locking unit 40, the rear roof panel 22 operates the ajar switch 62 for detecting the completed or finished installation of the rear roof panel 22.

When receiving the completed or finished installation signal of the rear roof panel 22 from the ajar switch 62, the control unit 70 operates the magnet unit 50 for fixing the rear roof panel 22 to fix the steel plate 22c of the rear roof panel 22 (see FIG. 22).

As described above, when each of the front and rear ends of the rear roof panel 22 is mounted, the locking unit 40 and the magnet unit 50 lock the front and rear ends of the rear roof panel 22 to finish the installation of the rear roof panel 22.

To remove the rear roof panel 22, the occupant manipulates the unlock button 61, and then operates the micro-switch 49 by pulling the rear roof panel 22 using the handle 22d formed on the bottom surface of the rear roof panel 22 (see FIG. 22).

When the micro-switch 49 is operated after the manipulation of the unlock button 61, the locking unit 40 and the magnet unit 50 fixing the rear roof panel 22 are unlocked, and the occupant lifts the rear roof panel 22 to finish the removal of the rear roof panel 22.

While several embodiments of the present disclosure have been described with reference to the accompanying drawings, those of ordinary skill in the art should understand that the present disclosure may be carried out in various other specific forms without departing from the inventive concept of the present disclosure and without changing the technical spirit or an essential feature of the present disclosure. Therefore, it should be understood that the above-described embodiments are illustrative in all aspects and do not limit the present disclosure.

What is claimed is:

1. A detachable roof panel assembly for a vehicle, the detachable roof panel assembly comprising:
a plurality of roof panels configured to be attached to and detached from a roof of the vehicle; and
a locking unit coupled to the roof of the vehicle and configured to lock predetermined positions of each roof panel of the plurality of roof panels.

2. The detachable roof panel assembly of claim 1, wherein the locking unit is configured to constrain and lock strikers coupled to each roof panel of the plurality of roof panels when the plurality of roof panels is mounted on the roof.

3. The detachable roof panel assembly of claim 2, wherein the locking unit includes:
a locking bar configured to constrain the strikers or to be moved rearward when pressed by the strikers; and
a solenoid configured to allow the locking bar to move rearward when electric power is applied to separate the locking bar from the striker.

4. The detachable roof panel assembly of claim 3, wherein a front end of the locking bar is formed to have an inclined surface to slide toward an inside of the solenoid when pressed by the striker.

5. The detachable roof panel assembly of claim 3, wherein the solenoid elastically supports the locking bar so that the locking bar moves forward when the electric power is cut off.

6. The detachable roof panel assembly of claim 1, wherein the plurality of roof panels comprises a front roof panel and a rear roof panel, and wherein the locking unit is on a center roof rail of the vehicle to lock a rear end of the front roof panel and a front end of the rear roof panel.

7. The detachable roof panel assembly of claim 1, further comprising a magnet unit configured to fix at least one side of each of the plurality of roof panels to the roof with a magnetic force.

8. The detachable roof panel assembly of claim 7, wherein the magnet unit includes:
a magnetic iron core in contact with steel plates on each of the plurality of roof panels;
a fixed permanent magnet fixedly on the magnetic iron core;
a rotary permanent magnet rotatably disposed at a position spaced by a predetermined distance from the fixed permanent magnet of the magnetic iron core; and
a coil wound around the magnetic iron core and magnetized when electric power is applied to rotate the rotary permanent magnet.

9. The detachable roof panel assembly of claim 8, wherein, when the electric power is applied to the coil and when the rotary permanent magnet is arranged in the same direction as the fixed permanent magnet in a state in which the steel plates are attached to the magnetic iron core, a magnetic path is formed to pass through the magnetic iron core and the steel plates so that the plurality of roof panels is fixed to the roof.

10. The detachable roof panel assembly of claim 8, wherein, when the electric power is applied to the coil and when the rotary permanent magnet and the fixed permanent magnet are arranged in opposite directions, a magnetic path passing through the steel plates is removed so that the plurality of roof panels is separated from the roof.

11. The detachable roof panel assembly of claim 7, wherein the magnet unit is disposed on a center roof rail of the vehicle at an interval to fix a rear end of a front roof panel of the plurality of roof panels and a front end of a rear roof panel of the plurality of roof panels, and is on an upper end of a rear pillar of the vehicle to fix a rear end of the rear roof panel.

12. The detachable roof panel assembly of claim 1, further comprising an ajar switch configured to detect whether installation of the plurality of roof panels is finished.

13. The detachable roof panel assembly of claim 12, further comprising a control unit configured to:
receive a signal from the ajar switch whether the installation of the plurality of roof panels is finished;
output a locking signal of the locking unit or receive an unlock signal generated by pulling the roof panel by an occupant from the locking unit; and
operate a magnet unit configured to fix the roof panel with a magnetic force.

14. The detachable roof panel assembly of claim 13, wherein:
an unlock button is configured to be manipulated by the occupant before the occupant operates a micro-switch of the locking unit by pulling the roof panel; and
an output signal of the unlock button is input to the control unit.

15. The detachable roof panel assembly of claim 1, wherein any one of the plurality of roof panels includes:
a guide pin protruding toward a roof rail of the vehicle at one side thereof; and
a guide holder configured to accommodate the guide pin in the roof rail.

16. The detachable roof panel assembly of claim 15, wherein an accommodating groove configured to accommodate the guide pin is inside the guide holder.

17. The detachable roof panel assembly of claim 16, wherein:
the guide pin has a smaller cross-sectional area toward an end portion thereof and has a spherical head on the end portion of the guide pin; and
an inner end portion of the accommodating groove is formed in a shape corresponding to the head.

18. The detachable roof panel assembly of claim 17, wherein the accommodating groove is inclined toward the top of the vehicle.

19. The detachable roof panel assembly of claim 17, wherein the accommodating groove has a larger width toward an inlet thereof.

20. The detachable roof panel assembly of claim 15, wherein:
the guide pins are disposed at intervals on a front end of a front roof panel of a plurality of roof panels in a width direction of the vehicle; and
the guide holders are disposed at intervals on a front roof rail in the width direction of the vehicle.
